(19) United States
(12) Patent Application Publication
(10) Pub. No.: US 2024/0272122 A1
(43) Pub. Date: Aug. 15, 2024

(54) Analyzing Moisture Sensitive/Reactive Gases

(71) Applicants: PerkinElmer Health Sciences Canada, Inc., Woodbridge (CA); Perkin Elmer Yuhan Hoesa, Seoul (KR)

(72) Inventor: Chady Stephan, Brampton (CA)

(21) Appl. No.: 18/109,094

(22) Filed: Feb. 13, 2023

(51) Int. Cl. G01N 27/68; G01N 21/71; G01N 30/72

(52) U.S. Cl. CPC G01N 27/68; G01N 21/714; G01N 30/72

(57) ABSTRACT

Systems and methods for use in introducing samples to an analytical instrument. In particular, systems and methods to process moisture sensitive/reactive gases and then analyze by an analytical device/instrument using also a liquid calibrant sample. Suitable analytical devices include, for example, an inductively coupled plasma-mass spectrometer or inductively coupled plasma-optical emission spectrometer.

### CROSS-REFERENCE TO RELATED APPLICATIONS

This application is related to co-pending applications to U.S. Ser. No. 16/519,925, filed Jul. 23, 2019, and U.S. Ser. No. ______, filed ______ (Attorney Docket 008916.00379) each of which is incorporated by reference in its entirety.

### FIELD

Aspects described herein generally relate to systems and methods to process moisture sensitive/reactive gases and then analyze by an analytical device/instrument using also a liquid calibrant sample. Suitable analytical devices include, for example, an inductively coupled plasma-mass spectrometer or inductively coupled plasma-optical emission spectrometer.

### BACKGROUND

Mass analysis, and more particularly mass spectrometry, is an effective analytical technique for identifying unknown compounds and for determining the precise mass of known compounds. Advantageously, compounds can be detected or analyzed in minute quantities, allowing compounds to be identified at very low concentrations in chemically complex mixtures. Spectrometry, including inductively coupled plasma mass spectrometry (“ICP-MS”) and inductively coupled plasma-optical emission spectrometry (ICP-OES), has found practical application in a variety of fields, including medicine, pharmacology, food sciences, semi-conductor manufacturing, environmental sciences, and security. For example, preparation of semiconductors requires process gases with no, or extremely low amounts of, contaminants, and hence requires suitable testing methods.

A typical mass spectrometer includes an ion source that ionizes compounds, metals and particles of interest. Conventional ion sources may, for example, create ions by electrospray, chemical ionization or plasma ionization. The ions are passed to an analyzer region, where they are separated according to their mass (m)-to-charge (z) ratios (m/z). The separated ions are then detected at a detector. A signal from the detector may be sent to a computing or similar device where the m/z ratios may be stored together with their relative abundance for presentation in the format of an m/z spectrum.

In ICP-MS analysis, samples are introduced into an argon plasma as aerosol droplets. The plasma dries the aerosol, dissociates the molecules, then removes an electron from the components, thereby forming primarily singly-charged ions, which are directed into a mass filtering device known as a mass spectrometer.

Most ICP-MS instruments include the following components: a sample introduction system most commonly composed of a nebulizer and spray chamber; an ICP torch and RF coil for generating the argon plasma that serves as the ion source; an interface that links the atmospheric pressure ICP ion source to a high vacuum mass spectrometer; a vacuum system that provides high vacuum for ion optics, a quadrupole, and a detector; a collision/reaction cell that precedes the mass spectrometer and is used to remove interferences that can degrade achievable detection limits; ion optics that guide the desired ions into the quadrupole while assuring that neutral species and photons are discarded from the ion beam; a mass spectrometer that acts as a mass filter to sort ions by their mass-to-charge ratio (m/z); a detector that counts individual ions exiting the quadrupole; and a data handling and system controller that controls aspects of instrument control and data handling for use in obtaining final concentration results.

In ICP-OES analysis, a sample may be injected into a plasma and the resulting excitation of the sample in the plasma generates charged ions. As various molecules in the sample break up into their respective atoms, which then lose electrons and recombine repeatedly in the plasma, they emit radiation at a characteristic wavelength of the elements involved. A spectrometer may receive light from a light source (e.g., ICP-OES plasma or other light source including but not limited to a telescope, microscope, or other light-generating or light-conveying system).

However, it is difficult to directly analyze gases by ICP-MS or ICP-OES as such gas will destabilize the argon-based plasma and it is more challenging to analyze moisture sensitive/reactive gases while performing Method of Standard Addition (MSA) using liquid standards.

### SUMMARY

The following presents a simplified summary of various features described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards systems and methods for direct introduction and analyses of moisture sensitive gases by mode of method of standard addition using liquid standards.

One aspect is directed to a system configured to calibrate an analytical device and analyze gas samples, the system comprising at least a sample gas exchange apparatus and a calibration gas exchange apparatus. The sample gas exchange apparatus has a first gas exchange device having an inlet aperture and an outlet aperture and a first conduit coupled to the outlet aperture and configured to transfer a gaseous contaminant stream from the outlet aperture to the analytical device. The calibration gas exchange apparatus has a second gas exchange device having an inlet aperture to accept an aerosolized calibrant stream and an outlet aperture and a second conduit coupled to the outlet aperture and configured to transfer a gaseous calibrant stream from the outlet aperture to the analytical device. The first conduit and second conduit join to form a single conduit for transfer of a combination of the gaseous contaminant stream and the gaseous calibrant stream to the analytical device.

A further aspect relates to a method of calibrating an analytical device and analyzing gas samples. The method includes a) transferring a gaseous sample stream from a gaseous sample source to a first gas exchange device; passing the gaseous sample stream through the first gas exchange device; injecting exchange gas through the first gas exchange device countercurrent to the gaseous sample stream; passing an output of the first gas exchange device to an analytical device; and monitoring an output flow rate of the first gas exchange device; b) transferring a liquid calibrant stream from a liquid calibrant source to a second gas exchange device, wherein the liquid calibrant stream is aerosolized prior to the second gas exchange device; passing the aerosolized calibrant stream through the second gas exchange device; injecting exchange gas through the second gas exchange device countercurrent to the aerosolized calibrant stream; passing an output of the second gas exchange device to the analytical device; and monitoring an output flow rate at the second gas exchange device; and c) combining the output of the first gas exchange device and the output of the second gas exchange device prior to the analytical device.

Another aspect relates to a kit having at least a sample gas exchange apparatus, a calibration gas exchange apparatus, and a connector.

A further aspect is directed to an alternate system configured to calibrate an analytical device and analyze gas samples, the system comprising at least a sample gas exchange apparatus and a calibration spray chamber apparatus. The sample gas exchange apparatus has a gas exchange device having an inlet aperture and an outlet aperture and a first conduit coupled to the outlet aperture and configured to transfer a gaseous contaminant stream from the outlet aperture to the analytical device. The calibration gas exchange apparatus has a spray chamber, e.g. glass, having an inlet aperture to accept a nebulized calibrant stream and an outlet aperture/conduit coupled to the spray chamber and configured to transfer a gaseous calibrant stream from the spray chamber to the analytical device. The first conduit joins the outlet aperture/conduit to form a single conduit for transfer of a combination of the gaseous contaminant stream and the gaseous calibrant stream to the analytical device.

A further aspect relates to a method of calibrating an analytical device and analyzing gas samples. The method includes a) transferring a gaseous sample stream from a gaseous sample source to a gas exchange device; passing the gaseous sample stream through the gas exchange device; injecting exchange gas through the gas exchange device countercurrent to the gaseous sample stream; passing an output of the gas exchange device to an analytical device; and monitoring an output flow rate of the first gas exchange device; b) transferring a liquid calibrant stream from a liquid calibrant source to a nebulizer; combining the liquid calibrant stream with a nebulizer gas and nebulizing the combination to form a nebulized calibrant stream; injecting the nebulized calibrant stream into a spray chamber to separate gas from liquid; forming a gaseous calibrant stream containing nebulizer gas and calibrant; passing the gaseous calibrant stream to the analytical device; and c) introducing the output of the gas exchange device into the gaseous calibrant stream of the spray chamber prior to the analytical device.

Another aspect relates to a kit having at least a sample gas exchange apparatus, a nebulizer, a spray chamber, and a connector

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts a flow chart of two gas exchange devices connected to a single analytical device in accordance with some embodiments.

FIG. 2 depicts a diagram showing a device for processing gaseous samples in a gas exchange device and forwarding to an analytical device in accordance with some embodiments.

FIG. 3 depicts a diagram showing a device for processing liquid samples in a gas exchange device and forwarding to an analytical device in accordance with some embodiments.

FIG. 4 depicts one example of a mixing connection in the form of a T-connection in accordance with some embodiments.

FIG. 5 depicts limit of detection (LOD) for two gas exchange devices.

FIG. 6 depicts mass spectrum for Class 10,000 Mg.

FIG. 7 depicts mass spectrum for Class 10,000 Cu.

FIG. 8 depicts ICP-MS results of a scan of lab air for Al27.

FIG. 9 depicts ICP-MS results of a scan of lab air for Fe56.

FIG. 10 depicts a flow chart of a single gas exchange device and a spray chamber connected to a single analytical device in accordance with some embodiments.

FIG. 11 depicts a diagram of a single gas exchange device and a spray chamber connected to a single analytical device in accordance with some embodiments.

FIG. 12 depicts details of a connection in accordance with some embodiment.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards systems and methods for preparing liquid and gaseous samples for introduction into an analytical instrument.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged,” and similar terms, is meant to include both direct and indirect, as well as fixed or removable, mounting, connecting, coupling, positioning, and engaging by any suitable methods known to those of skill in the art.

An analytical instrument may be used to process samples from a gas source (e.g. containing contaminants). Suitable analytical instruments include ICP-MS or ICP-OES, for example. A gas exchange device enables the direct measurement of trace levels of organometallic gases and metallic particulate by ICP-MS. See also US 20190221417A1, hereby incorporated by reference in its entirety, for time of flight ICP or an ICP-OES with simultaneous multi-element detection at the particle level.

By passing ambient air through the gas-exchange device, the organometallic gas molecules in the sample are quantitatively extracted and transferred to the ICP-MS system for detection as the metallic species. Benefits include avoiding sample pre-treatment, the ability to differentiate between organometallic gas molecules and particles contaminant, and the ability to measure particle size and particle number in gas sample.

The analytical instrument should be properly calibrated, typically via incremental calibrant concentrations from liquid standards. Use of such liquid calibration standards does not pose issues for non-moisture sensitive gases. However, moisture sensitive gases (i.e. C₄F₈, CH₂F₂) are very reactive to moisture in the calibrant stream. Thus moisture should be removed from the calibrant before introducing the calibrant into analytical instrument.

### System Using GEDs for Both Sample Gas and Liquid Calibrant

Both the gas samples and the liquid calibrant may be processed through respective gas exchange devices, sometimes also referred to as a desolvators. An exchange gas, typically argon is introduced into the gas exchange devices. Contaminants from the moisture sensitive gas are transferred into argon exchange gas. Calibrant from aerosolized liquid calibrant is transferred into argon exchange gas. The argon gas containing the contaminants and the argon gas containing the calibrant is introduced into an analytical instrument. For example, the two streams of argon gas may be merged together to form a combined stream prior to being introduced to the analytical instrument.

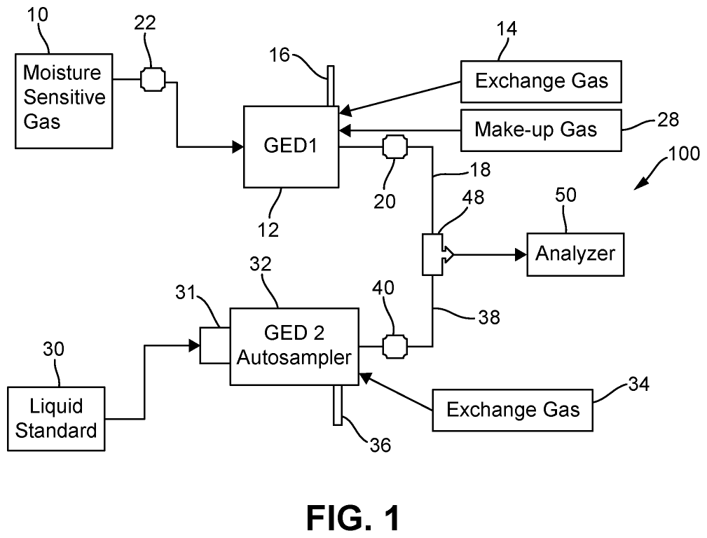

FIG. 1 depicts an example system 100. A gas exchange device and an analyzer are used to detect contaminants in a moisture sensitive gas stream. A gas exchange device is also used to process a liquid calibrant stream to calibrate the analyzer via a method of standard addition using liquid standards.

Moisture sensitive gas 10 is introduced into a gas exchange device 12 (GED 1). An exchange gas 14, e.g. argon, is introduced into the gas exchange device. Contaminants present in the moisture sensitive gas are transferred to the exchange gas in the gas exchange device 12. The moisture sensitive gas is removed from the gas exchange device via conduit 16. The exchange gas containing contaminants 18 exits from the gas exchange device 12 and is transported to analytical device 50. A mass flow meter 20 may be interfaced between the gas exchange device 12 and the analytical device 50 to control flow rate of the gaseous sample stream. A mass flow meter 22 may also be placed between the moisture sensitive gas source and the gas exchange device 12. If needed, make-up gas 28, e.g. nitrogen. may be added to or with the exchange gas to the GED.

Liquid standard 30 containing a calibrant is introduced into a gas exchange device 32 (GED 2) through an inlet aperture and typically via a nebulizer 31 which aerosolizes the liquid, creating a mist. An exchange gas 34, e.g. argon, is introduced into the gas exchange. Calibrant present in the aerosolized liquid is transferred to the exchange gas. The aerosolized liquid is removed from the gas exchange device via conduit 36. The exchange gas containing calibrant 38 exits gas exchange device 12 and is transported to analytical device 50. A mass flow meter 40 may be interfaced between the gas exchange device 32 and the analytical device 50. A mass flow meter may also be placed between the liquid calibrant source and the gas exchange device 32.

Each gas exchange device may comprise a cylindrical housing, extending along an axis, and enclosing a membrane for removal and transfer of particles from a gas stream or an aerosolized stream to the transfer gas stream. There should be compatibility between sample gas and exchange membrane. Conduit 18 and conduit 38 may be connected via a mixing connection 48, prior to entering the analyzer 50. The mixing connection may be any suitable connection such as T-connection, a Y-connection, or suitable venturis. Such connections may be made with any suitable polymer such as, but not limited to, perfluoroalkoxy alkanes (PFA.)

Although the elements of FIG. 1 are shown as block diagrams, the disclosure is not so limited. In particular, one or more of the boxes in FIG. 1 may be combined into a single box or the functionality performed by a single box may be divided across multiple existing or new boxes. For example, nebulizer 31 may be proximate the entrance to gas analyzer 32 which may be part of the gas analyzer or may be positioned away, or spaced apart, from gas analyzer 32.

Some embodiments are therefore directed to a system configured to calibrate an analytical device and analyze gas samples and includes at least a sample gas exchange apparatus and a calibration gas exchange apparatus.

### Sample Gas Exchange Apparatus

Any suitable gas exchange device may be used that can transfer contaminants out of a moisture sensitive gas to a transfer gas, e.g. Argon.

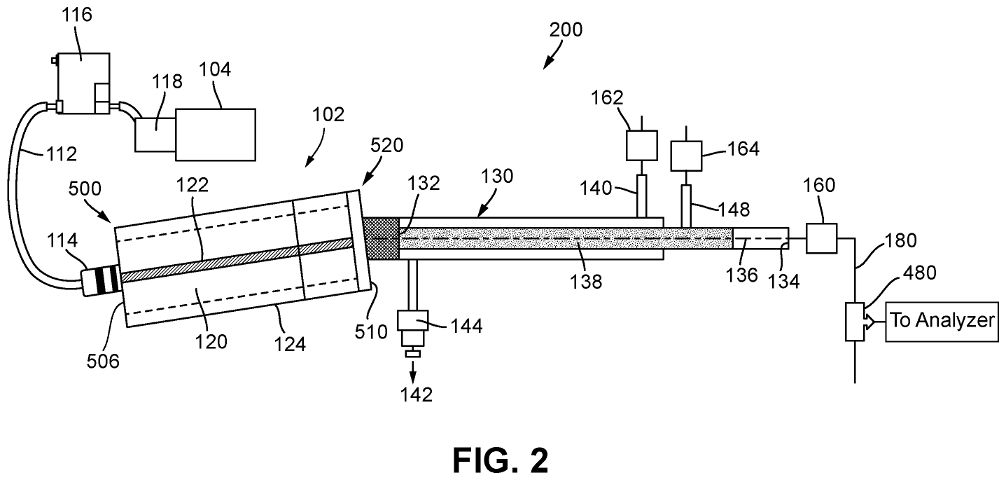

FIG. 2 illustrates system 200 having a gas chamber 102 optionally attached to a gas exchange device 130. The gas chamber 102 may optionally include a gas channel 122 positioned within an interior chamber 120 and connected at one end to the gas inlet port 504 at the inlet end 500. The gas channel transfers gas between the inlet end and outlet end of the housing without any loss of gaseous sample and without loss of pressure.

Mass flow controller 116 is used to control the flow rate of the sample gas from gaseous sample source 104 (which may represent different gas sources) via a gas flow conduit 112 that is coupled to chamber 102 by connector 114. A selector valve 118 at the gaseous sample source 104 may be utilized to switch between different gaseous sample sources, such that a variety of gaseous samples each may be introduced to an analyzer with system 200.

In gas chamber 102, gas channel 122 extends the length of the interior chamber 120 from gas inlet port 504 at the inlet wall 506 to the outlet port 512 at the outlet wall 510 and discharges to the inlet 132 of the gas exchange device 130. Flow of gaseous sample through chamber 102 is directed through gas channel 122. Gas channel 322 may be positioned along the axis of the chamber or may be offset toward the chamber wall. Generally, gas channel 122 will be positioned so that it extends directly from gas inlet port 504 to outlet port 512 for an unobstructed flow path. Thus, the length of the gas channel typically corresponds to the length of the chamber 102 between the inlet end 500 and the outlet end 520.

Gas channel 122 may be flexible or rigid. It may be constructed of the same material that is used to line the interior wall 124 of the interior chamber 120 or a different material. In one aspect, the material is selected to be inert to the gaseous samples being processed. In certain examples, the gas channel 122 may comprise PFA or PTFE tubing. The diameter and thickness of the gas channel 122 also will depend at least in part on the location and size of the gas inlet port 504 and outlet port 512. In one aspect, gas channel comprises 0.25 inch diameter PTFE tubing. Gas channel 122 is connected to ports 504, 512 using any suitable connector to provide a secure and sealed connection.

If additional support is required for the gas channel 122 during operation, other features known to one of skill in the art, such as baffles, may be included to support or secure the gas channel.

Chamber 102 is connected to gas exchange device 130. When a gaseous sample is processed in system 200, the gaseous sample flow rate from the sample source 104 through the gas channel 122 and into gas exchange device 130 is measured and controlled using known techniques to limit pressure changes and facilitate proper gas exchange at the enclosed membrane 138. In certain aspects, a positive pressure is maintained to move the gaseous sample through the system 100 toward and into the gas exchange device 130. The flow rate of exchange gas from the enclosed membrane 138 also may be controlled to be consistent with the flow rate of process gas. In certain aspects, a mass flow meter 160 may be interfaced between the gas exchange device and the analytical device and tied to the mass flow controller 116. In embodiments, the mass flow meter 160 is in communication with the computer.

The membrane 138 of gas exchange device 130 may be enclosed in a heater, and temperature is controlled between 80 and 180 C. Temperature control in conjunction with the exchange gas flow/pressure are the two fundamental parameters that ensure proper/efficient exchange. The pressure within gas exchange device 130 may be measured and controlled by a pressure gauge 144, in flow communication with the interior of the gas exchange device 130. The gas pressure should be constant from the inlet to the outlet of the gas exchange device and sufficiently high to ensure that the exchange gas is being transferred into the enclosed membrane and the sample gas is being transferred out of the enclosed membrane. Suitable pressures include 0.1 to 2 KPa, for example, 0.3 KPa The flow of gaseous sample through inlet 132 and outlet 134 may be controlled using techniques known to those of skill in the art. For example, the exchange gas may be set at a flow rate of 1 to 15 L/min, or 1 to 12 L/min, or 3 to 10 L/min for example 8 L/min in order to obtain the desired pressure.

If additional gas flow is needed to maintain or adjust the pressure across the membrane 138 to obtain a desired gas exchange rate, makeup gas may be introduced into gas exchange device 130 at makeup port 148. Makeup gas may be the same gas as exchange gas or may be a different gas such as nitrogen. The makeup gas may flow through and exit gas exchange device 130 with exchange gas. The makeup gas may also be used to increase the flowrate of the sample gas flow. For example, makeup gas is added a very low flow (0-50 mL) Makeup gas also may be introduced at other positions in system 200 to achieve the desired control of sample gas flow and system pressure. In one example embodiment where the exchange gas is argon, the makeup gas may be nitrogen, and the amount of makeup gas is determined while calibrating the disclosed methods and systems with a liquid standard. Nitrogen, for example, aids in transferring the energy from the argon plasma to the contaminant in the absence of (moisture or water molecule—H₂O).

In regard to gaseous samples, the flow rate or pressure at the outlet 134 of the gas exchange device 130 should be close to or the same as the flow rate or pressure of the sample gas measured at the mass flow controller 116 in order to maintain a linear response of contaminants to concentration. The mass flow meter 160 may be used to measure a flow of gas to the analytical device and the ratio of this value to that set by mass flow controller 116 may be monitored e.g., by the computer. Ideally the flow of gas is at least 98%, or at least 99%, of the flow of the gaseous sample as measured by the mass flow controller of the gaseous sample.

### Calibration Gas Exchange Apparatus

Any suitable gas exchange device may be used that can transfer a calibrant out of an aerosolized liquid to a transfer gas, e.g. Argon.

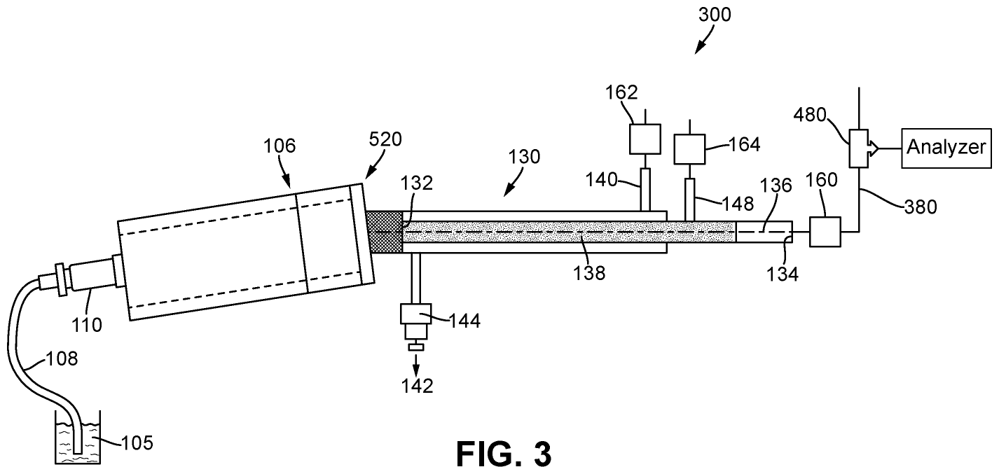

FIG. 3 depicts an illustrative arrangement of equipment in a system 300 for preparing a liquid sample for introduction to an analytical instrument. The liquid sample may be conveyed, such as by pumping, from the liquid sample source 105 via a liquid flow conduit 108 and injected into a nebulizer 110 in which the liquid sample is nebulized into a mist or aerosol. From the nebulizer 110, the liquid sample mist is injected into the chamber 106. In certain aspects, chamber 106 may be a spray chamber such as known to one of skill in the art. Any suitable nebulizer may be used. A variety of nebulizers, such as glass or PFA concentric nebulizers, are commercially-available from e.g., Meinhard, Savillex and Elemental Scientific.

The liquid sample mist flows from the nebulizer 110 into an interior of spray chamber 106, which is positioned in an interior portion of an outer housing of the chamber 106. The interior may be heated, for example to a temperature in excess of the vaporization temperature of the liquid sample, e.g. 30 to 130° C. Heating the spray chamber 106 evaporates the liquid part of the aerosol facilitating its exchange in the GED 130.

In certain embodiments, the temperature in the interior chamber is maintained from about 40° C. to about 150° C., and more preferably between about 70° C. and about 110° C. The resulting aerosol droplets of the liquid sample can then be caused to flow through the interior chamber, typically under the influence of the pressure gradient, from the inlet end 500 of the chamber 106 to the outlet end 520 and into the gas exchange device 130.

Chamber 106 is connected to gas exchange device 130. In certain aspects, a positive pressure is maintained to move the sample through the system 300 toward and into the gas exchange device 130. The flow rate of exchange gas from the enclosed membrane 138 also may be controlled to be consistent with the flow rate of calibrant gas. In certain aspects, a mass flow meter 160 may be interfaced between the gas exchange device and the analytical device. In embodiments, the mass flow meter 160 is in communication with the computer.

As discussed above for system 200, if additional gas flow is needed to maintain or adjust the pressure across membrane 138 to obtain a desired gas exchange rate, makeup gas may be introduced into gas exchange device 130 at makeup port 148. Makeup gas may be the same gas as exchange gas or may be a different gas. The makeup gas may flow through and exit gas exchange device 130 with exchange gas. The makeup gas may also be used to increase the flowrate of the sample gas flow. Makeup gas also may be introduced at other positions in system 200 to achieve the desired control of sample gas flow and system pressure.

In the gas exchange device 130, the membrane 138 may be enclosed in a heater, and temperature is controlled between 80 and 180 C. Temperature control in conjunction with the exchange gas flow/pressure are the two fundamental parameters that ensure proper/efficient exchange. The pressure within gas exchange device 130 may be measured and controlled by a pressure gauge 144, in flow communication with the interior of the gas exchange device 138. The gas pressure should be constant from the inlet to the outlet of the gas exchange device and sufficiently high to ensure that the exchange gas is being transferred into the enclosed membrane and the sample gas is being transferred out of the enclosed membrane. Suitable pressures include 0.1 to 2 KPa, for example, 0.3 KPa. The flow of aerosolized liquid sample through inlet 132 and outlet 134 may be controlled using techniques known to those of skill in the art. For example, the exchange gas may be set at a flow rate of 1 to 15 L/min, or 1 to 12 L/min, or 3 to 10 L/min for example 8 L/min in order to obtain the desired pressure.

### Introduction to Analyzer

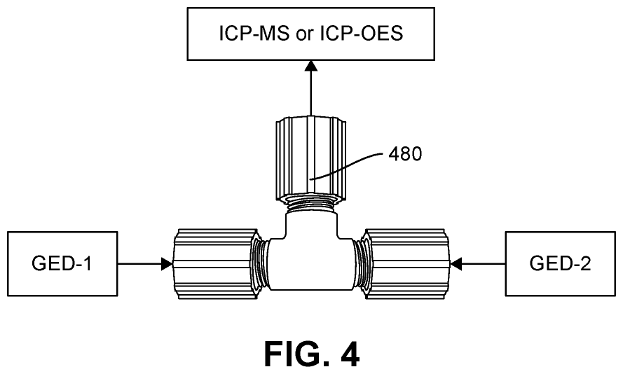

As seen in FIG. 4, the conduits from each gas exchange device join at connection 480 to transfer to a single conduit for flowing into the analytical device. Such connection may be any suitable connection such as, but not limited to, a T-connection as shown, a Y-connection (has a Y-shape instead of a T-shape), or a venturi. The analytical device may be an inductively coupled plasma-mass spectrometry (ICP-MS) or an inductively coupled plasma-optical emission spectrometry (ICP-OES).

If additional gas flow is needed to increase the flowrate of the gas flow to the analytical device, makeup gas may be introduced into gas exchange device 130 at makeup port 148. A mass flow controller 164 may be positioned near the makeup port 148. For example, makeup gas is nitrogen. For example, when the analytical device is an ICP-MS with an argon plasma and the exchange gas is argon, using nitrogen as a makeup gas may be desired as the nitrogen addition will assist conduct/transfer the argon plasma energy to the dry aerosol carried by the exchange gas stream, thus promoting proper atomization/ionization of elements in the argon plasma. As discussed below, the flow rate of nitrogen is determined during the calibration of the ICP-MS, for example, and then maintained throughout the process. Makeup gas also may be introduced at other positions in systems 100, 200 and 300 to achieve the desired control of sample gas flow and system pressure

The mass flow controller 116, mass flow meter 160, pressure gauge 144, and the like may be connected to a microprocessor-controlled device (“computer”), for example, to measure, monitor, and control the various inputs and flow rates. The computer may also be used to measure, monitor, and control all conditions including temperature and pressure. The computer may make adjustments based on the measured values, such as, e.g., changing flow rates, etc. In some embodiments, the computer may adjust the flow rate of the exchange gas, maintain the desired flow rate of the makeup gas, and/or control the pressure gauge and/or temperature to ensure desired conditions for maximum gas exchange are achieved

It is to be understood that in each of the systems described herein, like features are indicated by like reference numbers and operate in a like manner in each system.

### Method of Calibrating

Some embodiments are also directed to a method of calibrating an analytical device and analyzing gas samples. A gaseous sample stream may be transferred from a gaseous sample source to a gas exchange device; passing the gaseous sample stream through the gas exchange device. An exchange gas stream flows through the gas exchange device countercurrent to the gaseous sample stream and then passes through an output of the first gas exchange device and flows to an analytical device. Any of the flow rates may be monitored such as the output flow rate of the first gas exchange device. Makeup gas may be injected into the output from the first gas exchange device to provide the output flow rate that is at least 98% of the flow rate of the gaseous sample stream from the gaseous sample source. At least 99.8% of gas of the gaseous sample stream is exchanged with the exchange gas in the first gas exchange device. The exchange gas may be any suitable gas, but typically is Argon. Flow rates for the gaseous samples may be 0 to 2 L/min, for example 0.2 to 1.8 L/min, or 0.4 to 1.5 L/min. Exchange gas flow rate between 0 and 12 L/min. Makeup gas may be between 0 and 50 mL/min, for example, about 1 to 45 mL/min.

A liquid calibrant stream may be transferred from a liquid calibrant source to a second gas exchange device. The liquid calibrant stream may be aerosolized prior to the second gas exchange device and the aerosolized calibrant stream passed through the second gas exchange device. An exchange gas flows though through the second gas exchange device countercurrent to the aerosolized calibrant stream and then passes through an output of the second gas exchange device and flows to the analytical device. Any of the flow rates may be monitored such as the output flow rate of the second gas exchange device. The flow rate of the liquid calibrant stream is at least 0.8 l/min.

The output of the first gas exchange device and the output of the second gas exchange device are then combined prior to the analytical device.

The method may be repeated for multiple liquid calibrant streams, each liquid calibrant stream containing a different amount of calibrant in order to calculate a calibration curve.

Some embodiments are also directed to a kit to for calibrating an analytical device and analyzing gas samples. The kit has at least a sample gas exchange apparatus, a calibration gas exchange apparatus, and a connector, for example a T-connector. The sample gas exchange apparatus may have a gas exchange device having an inlet aperture and an outlet aperture and a conduit configured to couple to the outlet aperture to transfer a gaseous contaminant stream from the outlet aperture to the analytical device. The calibration gas exchange apparatus may have a second gas exchange device having an inlet aperture to accept an aerosolized calibrant sample stream and an outlet aperture, and a second conduit configured to couple to the outlet aperture to transfer a gaseous calibrant stream from the outlet aperture to the analytical device. The connector is configured to join the first conduit and second conduit. The kit may further have a third conduit to transfer of a combination of the gaseous contaminant stream and the gaseous calibrant stream to the analytical device.

The kit may further contain a gas flow conduit configured to couple to the inlet aperture of the first gas exchange device. The kit may further contain a nebulizer configured to connect to the inlet aperture of the second gas exchange device and a liquid flow conduit configured to connect to the nebulizer. The kit may contain at least one or two mass flow controllers, and at least one or two mass flow meters.

The first gas exchange device, the second gas exchange device, or both may be made of a cylindrical housing, extending along an axis, and enclosing a membrane for removal and transfer of particles, and having an exchange gas inlet port and exchange gas outlet port. At least one mass flow controller or mass flow meter. The analytical device is an inductively coupled plasma-mass spectrometry (ICP-MS).

### Gaseous Samples

At times, it may be desired to analyze one or more gaseous samples. Gaseous samples may be processed in system 100 as well. The gaseous sample stream may contain at least one contaminant selected from the group consisting of transition metals and heavy metals such as, but not limited to, Na, Mg, Al, Mo, W, Pb, Ti, Cr, Fe, Ni, Co, Cu, Zn, K, Ca, and Mn and the liquid calibrant stream contains the at least one contaminant

Gaseous samples that may be prepared using system 100 include, but are not limited to those gases listed in Table 1 and air (ambient/lab).

TABLE 1

| Tested | Possible Gases | Others* |
|---|---|---|
| He | CHF₃ | C₂HF₅ |
| LAr | CF₄ | 100% C₄F₈ |
| LN₂ | C₃H₆ | 100% CH₂F₂ |
| N₂O | C₂H₄/He | 100% C₂HF₅ |
| NF₃ | CH₄/Ar | 100% Si₂H₆ |
| 100% NH₃ | 5% H₂/4% N₂ | 20% PH₃/H₂ |
| CO₂ | 4% H₂/N₂ | 10% GeH₄/He |
| C₄H₂F6 | 100% C₂H₄ | 10% Ge₂H₆/H₂ |
| CO | 100% CH₄ | |
| SF₆ | BF₃ | |
| | 1% BCl₃/N₂ | |
| | 20% F₂/N₂ | |
| | O₂/He | |
| | 1.2% He/N₂ | |
| | 100CH₂F₂ | |
| | 5% PH₃/N₂ | |
| | 0.1% B₂H₆/H₂ | |
| | 4% PH₃/He | |

*Need to modify GED (safety and temperature control)

In certain aspects, the efficiency of the gas exchange device 130 is about 97% or greater, about 97.98% or greater, about 98% or greater, or about 99% or greater.

The analyzer may be initially calibrated using liquid standards according to calibration techniques known to those of skill in the art. Based on the calibration, the desired flow rates of the gaseous sample mass flow controller 116, exchange gas mass flow controller 162, and/or makeup gas (e.g., nitrogen) mass flow controller 164 may be determined. These values are generally set at the beginning of the process and then monitored.

Once the particle-containing liquid samples and/or gaseous samples are processed in any of the systems described herein, data generated by the analytical device 150 can be analyzed by techniques known to those of skill in the art, including techniques described in U.S. Patent Application Publication No. 2015/0235833, the disclosure of which is incorporated herein in its entirety.

It is to be understood that any gas phase or particle sample analysis system is to be considered equivalent and may be used instead.

### EXAMPLE

A gas exchange device contains a temperature-controlled spray chamber set at 110° C. (range can vary from −5 C to 130° C.) The spray chamber is connected to a temperature controlled desolvator set at from 20° C. to 150° C.), generally 140° C. Ar sweep gas is introduced into the desolvator between 0 and 15 L/min, such as 3 to 5 L/min, generally about 3.5 L/min. N2 addition gas is introduced into the desolvator between 0 and 15 mL/min, such as 2 to 5 mL/min, generally about 3 mL/min. When compared to common baffled spray chamber GED sensitivity running common liquid standards is anywhere between 5 and 8× increase in sensitivity. The Ar sweep gas may be changed in increments of 0.1 L/min and N2 may be changed in increments of 0.1 mL/min to achieve maximum sensitivity.

Instrument sensitivity comparing Std Cyclonic vs GED using Argon as a sample gas. This test is performed to baseline the system prior to using other sample gases. When the GED is used with aqueous standards introduced in the heated spray chamber and then transferred to the heated desolvator membrane. Moisture is removed and the dry aerosols containing the metallic elements is then transferred to the analyzer. The energy from the plasma (the ionization source) in the analyzer is solely consumed by the metallic elements considerably enhancing respective atomization and ionization thus yielding improved intensity. No Plasma energy is used to evaporate moisture

| | | | | | | | | CeO 156/ | Ce++ 70/ |
|---|---|---|---|---|---|---|---|---|---|
| | Be 9 | In 115 | U 238 | CeO 156 | Ce 140 | Ce++ 70 | Bkgd 220 | Ce 140 (%) | Ce 140 (%) |
| Std. - | 11168 | 128470 | 188957 | 2452 | 113853 | 1947 | 0 | 2 | 2 |
| Cyclonic | | | | | | | | | |
| GED - | 85006 | 881851 | 1095352 | 171 | 813190 | 31390 | 0 | 0 | 2 |
| Argon | | | | | | | | | |
| GED/Std | 8 | 7 | 6 | | 7 | | | | |

The following table show the efficiency of the GED properly exchanging sample gases (Air and Nitrogen) with argon. This is monitored by observing similar sensitivity for Be, In, Ce and U when comparing Nitrogen and Air to Argon. It also shows the ability of the GED to exchange sample gas and eliminate moisture while maintaining equivalent sensitivity to when operated with Argon as a sample gas. Loss of sensitivity or performance will be observed if the sample gas was not optimally exchanged in the GED.

| | | | | | | | | CeO 156/ | Ce++ 70/ |
|---|---|---|---|---|---|---|---|---|---|
| | Be 9 | In 115 | U 238 | CeO 156 | Ce 140 | Ce++ 70 | Bkgd 220 | Ce 140 (%) | Ce 140 (%) |
| Std. - | 12271 | 155649 | 152260 | 2430 | 137809 | 3080 | 0 | 2 | 2 |
| Cyclonic | | | | | | | | | |
| GED - | 85006 | 881851 | 1095352 | 171 | 813190 | 31390 | 0 | 0 | 4 |
| Argon | | | | | | | | | |
| GED - | 85480 | 882373 | 1057964 | 95 | 744310 | 45015 | 0 | 0 | 6 |
| Nitrogen | | | | | | | | | |
| GED - | 82744 | 819148 | 1030059 | 1330 | 621602 | 46408 | 0 | 0 | 7 |
| Air Compr. | | | | | | | | | |

Prepare moisture sensitive gas samples (GED-1). Prepare multi-element standards 0.5, 1 and 1.5 ppb along with a blank (GED-2). Use 0.1% acid for stability and ultra-high purity (UHP) water. Run unspiked sample—moisture sensitive gas (GED-1) and GED-2 only running argon. For calibration—Method of Standard addition (MSA), Run blank (0.1% Nitric acid in UPA), Run standards, using GED 2.

### RESULTS

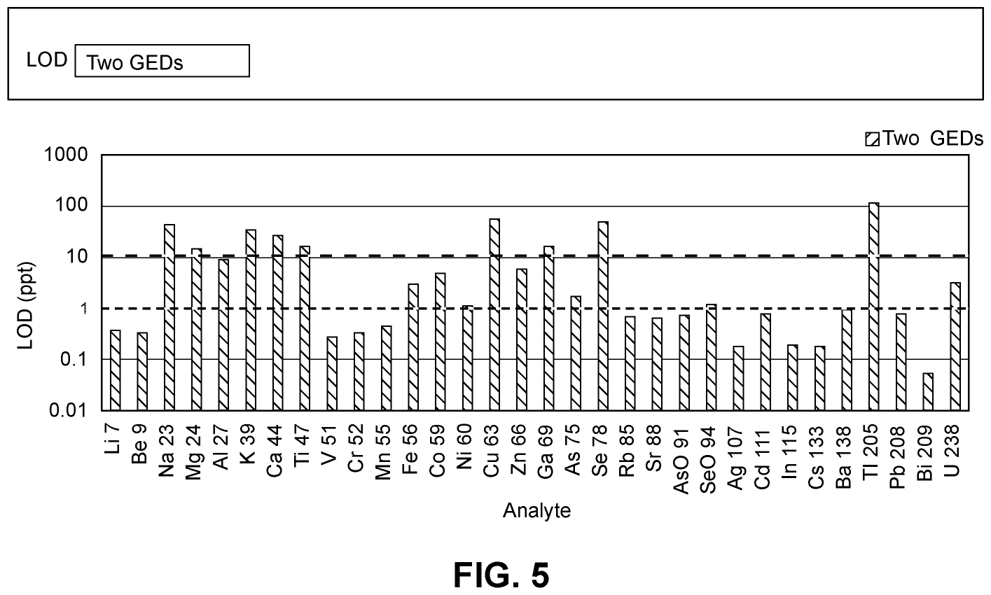

FIG. 5 depicts a LOD results for two gas exchange devices. The Table below indicates that a noticeable metallic impurity's increase from Class 100 top Class 10000 is observed.

| | | | | | | | | | | | | | | | | |
|---|---|---|---|---|---|---|---|---|---|---|---|---|---|---|---|---|
| | | | | | | | | | | | | | | | | Re- |
| Na | Mg | Al | Mo | W | Pb | Ti | Cr | Fe | Ni | Co | Cu | Zn | K | Ca | Mn | marks |

| | | | | | | | | | | | | | | | | | |
|---|---|---|---|---|---|---|---|---|---|---|---|---|---|---|---|---|---|
| Class | pg/L | 1.34 | 1 | 1.43 | 1.74 | 2.1 | 0.96 | 0.81 | 1.63 | 0.76 | 2.49 | 1.99 | 2.28 | 3.52 | 3.46 | 1.2 | 2.75 |
| 100 | ug/m3 | 0.001 | 0.001 | 0.001 | 0.002 | 0.002 | 1E−03 | 8E−04 | 0.002 | 8E−04 | 0.002 | 0.002 | 0.002 | 0.004 | 0.003 | 0.001 | 0.003 |
| Class | pg/L | 6.94 | 3.08 | 2.07 | 2.39 | 2.86 | 2.3 | 2.31 | 2.24 | 3.7 | 2.94 | 2.71 | 3.49 | 3.4 | 8.46 | 3.48 | 4.12 |
| 100000 | ug/m3 | 0.007 | 0.003 | 0.002 | 0.002 | 0.003 | 0.002 | 0.002 | 0.002 | 0.004 | 0.003 | 0.003 | 0.003 | 0.003 | 0.008 | 0.003 | 0.004 |

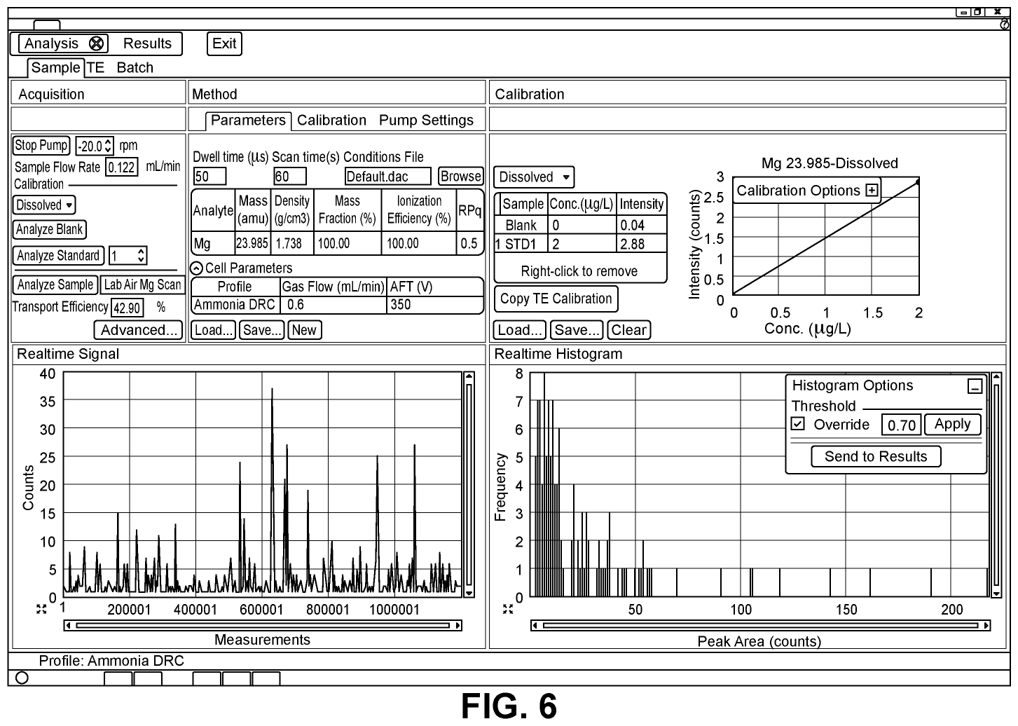

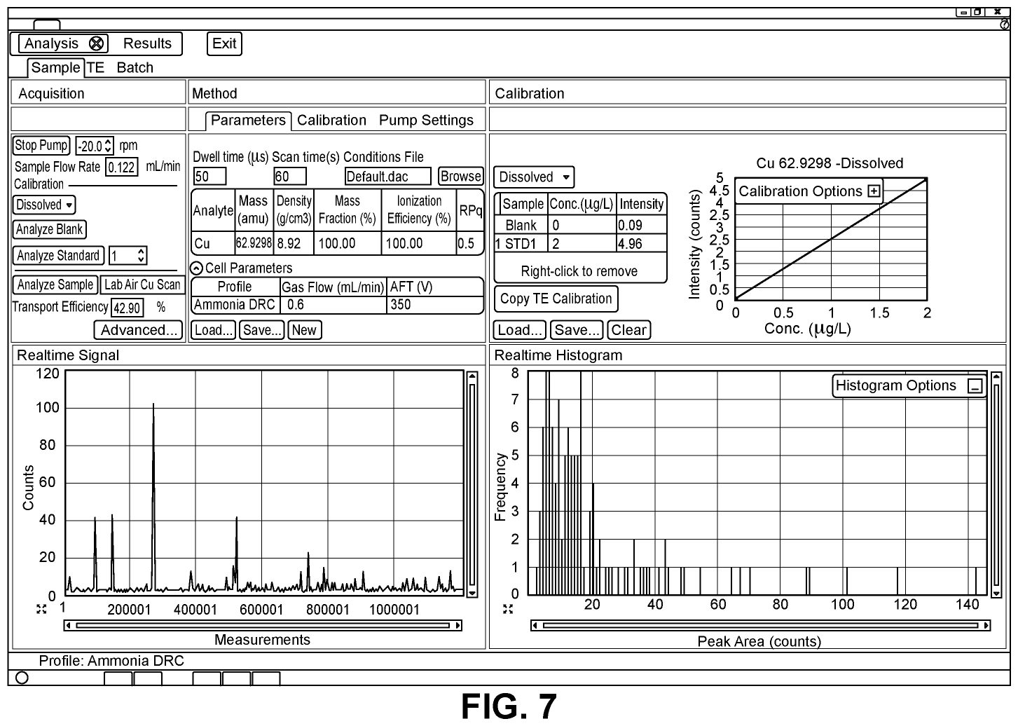

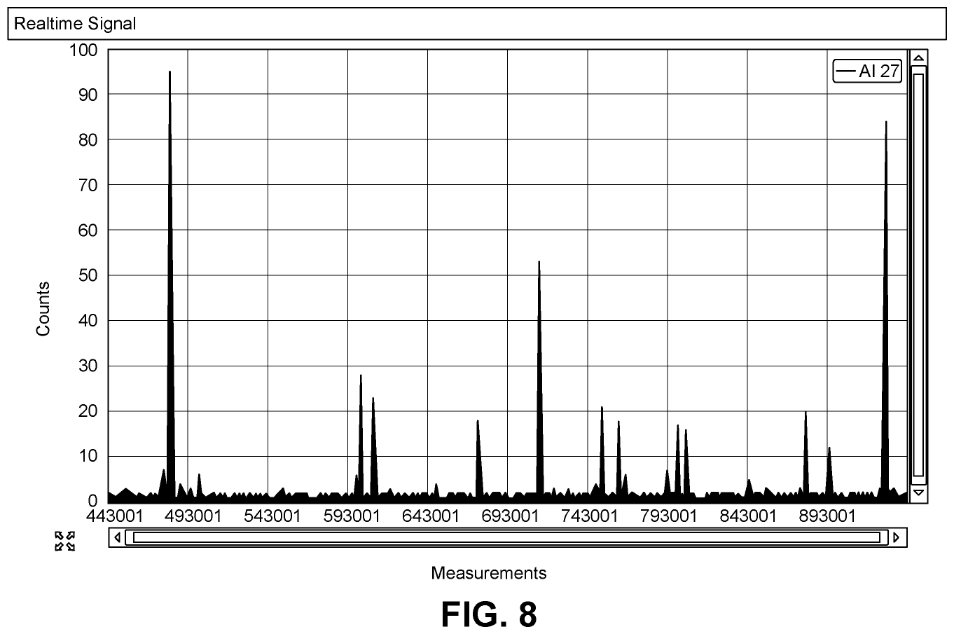

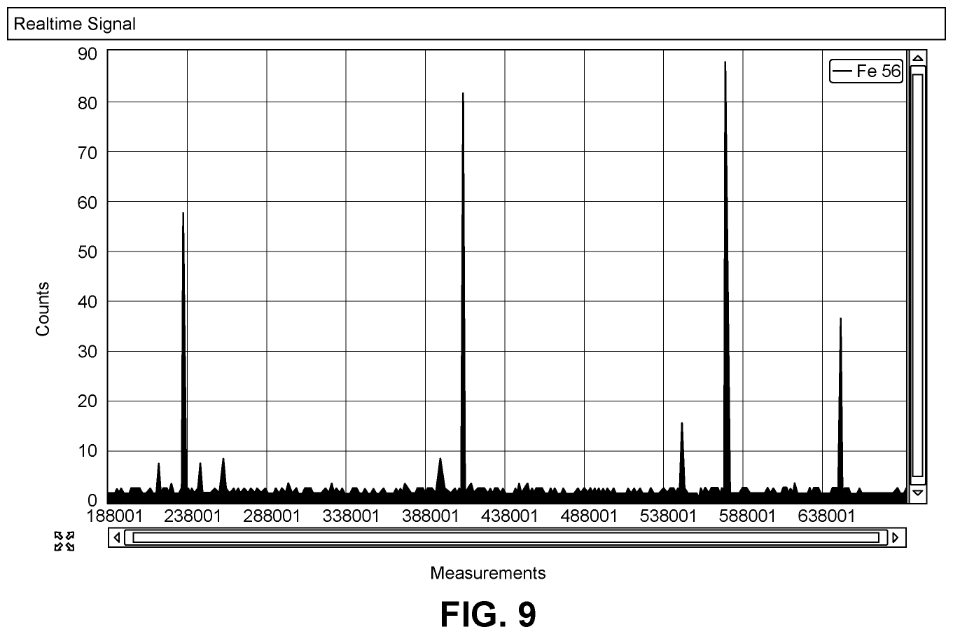

FIG. 6 depicts a mass spectrum of Class 10,000 Mg and FIG. 7 depicts a mass spectrum of Class 10,000 Cu. FIG. 8 depicts the ICP-MS results of a scan of lab air for A127 that utilized the disclosed methods and systems. FIG. 9 depicts the ICP-MS results of a scan of lab air for Fe56 that utilized the disclosed methods and systems.

### System Using GED for Sample Gas and a Spray Chamber for Liquid Calibrant

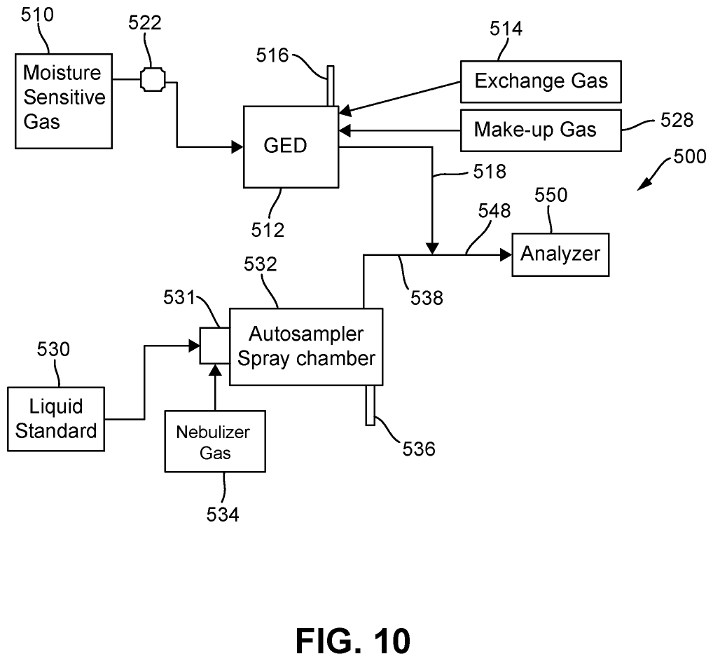

Another arrangement also utilizes a gas exchange device and an analyzer to detect contaminants in a moisture sensitive gas stream. In this aspect, however, instead of a gas exchange device for the liquid calibrant stream, a glass spray chamber with a dedicated entry port is used. A liquid calibrant stream and a nebulizer gas stream are introduced into the spray chamber via a nebulizer. The resulting stream of nebulized calibrant and nebulizer gas is then separated into a gaseous output containing calibrant and a liquid. The gaseous calibrant stream exits the spray chamber via a gas outlet. The output gas from the gas exchange device is introduced into the gas inlet port of the glass spray chamber and combined with the gaseous calibrant stream from the spray chamber. The combined streams are introduced into an analyzer. Impurities in the sample gas are analyzed using method of standard addition (MSA). Calibrant standards are prepared and introduced via the modified spray chamber. FIG. 10 provides details of system 500 directed to this arrangement. Although the elements of FIG. 10 are shown as block diagrams, the disclosure is not so limited.

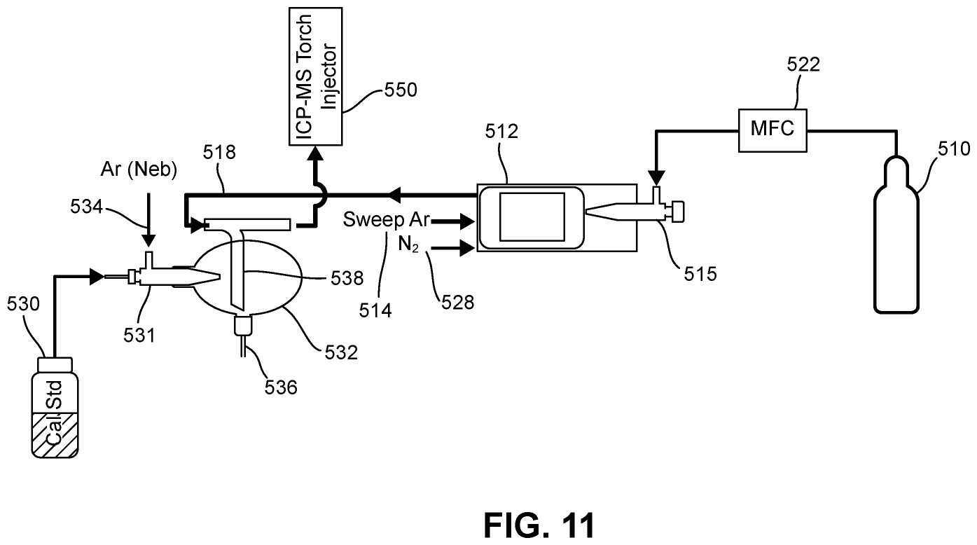

Similar to the aspect discussed for FIG. 1, moisture sensitive gas 510 is introduced into a gas exchange device 512 (GED). An exchange gas 514, e.g. argon, is introduced into the gas exchange device. Contaminants present in the moisture sensitive gas are transferred to the exchange gas in the gas exchange device 512. The moisture sensitive gas depleted of contaminants is removed from the gas exchange device via conduit 516. The exchange gas containing contaminants exits the gas exchange device, e.g. via conduit 518. A mass flow meter 522 may also be placed between the moisture sensitive gas source and the gas exchange device 512. As seen in FIG. 11, a nebulizer may be used to introduce the moisture sensitive gas.

The temperature in the GED range from 20° C. to 150° C., e.g. 140° C. The operating parameters such as flow rates may be as discussed above.

If additional gas flow is needed to maintain or adjust the pressure across the membrane in the GED 512, e.g. to obtain a desired gas exchange rate, makeup gas may be introduced into gas exchange device 512. Makeup gas may be the same gas as exchange gas or may be a different gas such as nitrogen 528. The makeup gas may flow through and exit gas exchange device 512 with exchange gas or may be introduced at other parts of the device as discussed above.

Flow rates for the gaseous samples may be 0 to 2 L/min, for example 0.2 to 1.8 L/min, or 0.4 to 1.5 L/min. Exchange gas flow rate between 0 and 12 L/min. Makeup gas may be between 0 and 50 mL/min, for example, about 1 to 45 mL/min.

A stream of liquid standard 530 containing a calibrant is introduced into a spray chamber 532 through an inlet aperture via a nebulizer 531. A nebulizer gas 534 is also introduced into the nebulizer 531. The liquid and nebulizer gas are combined and aspirated (aerosolized), creating a mist. Calibrant present in the aerosolized liquid is transferred to the nebulizer gas forming a gaseous calibrant stream. The gaseous calibrant stream exits spray chamber 532 via outlet port/conduit 538 at the top of the spray chamber and is transported to analytical device 550. Liquid remaining in the spray chamber is removed from the bottom of the spray chamber via conduit 536. Conduit 518 may combine with outlet port/conduit 538 via a connection 548 prior to entering the analyzer 550.

FIG. 11 provides additional details using corresponding identifying item numbers as FIG. 10. Sample gas is exchanged in the GED and the output is introduced into the additional gas port of the glass spray chamber. The calibration standard is aspirated using the nebulizer gas, e.g. Argon.

The spray chamber may be cyclonic baffled or not, made from glass, quartz, PFA or other materials. Any commonly used spray chamber for a plasma-based analyzer with additional input. Calibrants are nebulized in the spray chamber. Excess calibrant is drained from the spray chamber. Calibrant aerosol are carried to the plasma by the nebulizer gas. Aerosols are mixed with the GED output stream introduced via an input port. The input post is in linear alignment with the plasma to avoid cross sectional collision resulting in loss of sensitivity. The temperature of the spray chamber may be between −5 C and up to 110° C.

The flow rate of the liquid calibrant stream into the nebulizer can vary between 0.001 L/min and up to 1.5 L/min—depending on the type of spray chamber, nebulizer, and analyzer setup, and generally at least 0.2 l/min. The stream of liquid standard may be aspirated using a standard nebulizer gas operating with a gas such as argon. The flow rate of the nebulizer gas can range between 0.1 L/min and 1.5 L/min

As discussed above, the gas exchange device may comprise a cylindrical housing, extending along an axis, and enclosing a membrane for removal and transfer of particles from a gas stream or an aerosolized stream to the transfer gas stream. There should be compatibility between sample gas and exchange membrane.

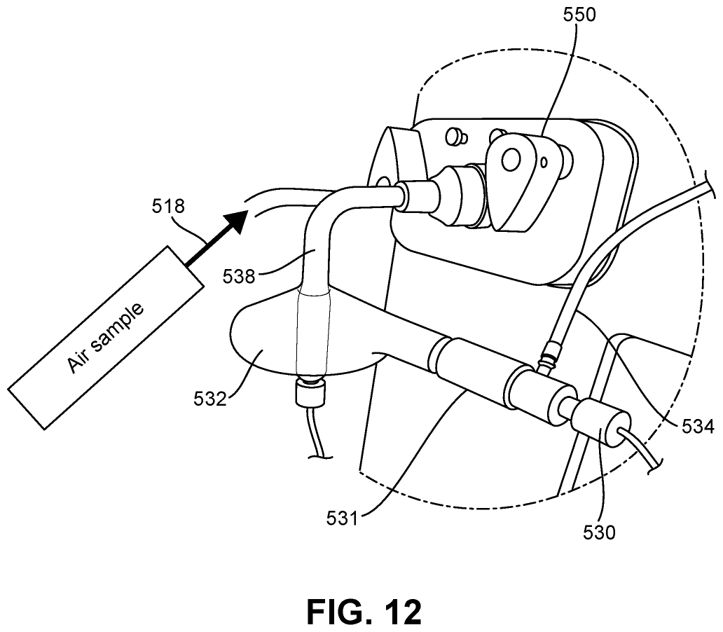

FIG. 12 depicts a connection 548. The conduit 516 is connected to outlet port/conduit 538 just before the analyzer 550. Importantly, the GED input is inline with plasma and prior to the aerosol coming from the spray chamber.

The gas exchange device and spray chamber are used in a method of calibrating an analytical device and analyzing gas samples. A gaseous sample stream is transferred from a gaseous sample source to a gas exchange device. The gaseous sample stream is passed through the gas exchange device. Exchange gas is injected through the gas exchange device countercurrent to the gaseous sample stream. The output of the gas exchange device is transferred to an analytical device. The output flow rate of the gas exchange device may be monitored.

A liquid calibrant stream from a liquid calibrant source is transferred to a nebulizer. A nebulizer gas is also introduced to the nebulizer. The combined nebulized liquid calibrant stream and nebulizer gas are introduced to the spray chamber. A gaseous calibrant stream formed in the spray chamber is removed and transferred to the analytical device. The output of the gas exchange device is introduced into the gaseous calibrant stream prior to the analytical device.

Clause 1: A system configured to calibrate an analytical device and analyze gas samples, the system comprising at least a sample gas exchange apparatus and a calibration apparatus; the sample gas exchange apparatus comprising: a gas exchange device having an inlet aperture and an outlet aperture; and a first conduit coupled to the outlet aperture and configured to transfer a gaseous contaminant stream from the outlet aperture to the analytical device, the calibration apparatus comprising: a spray chamber having an inlet aperture to accept an aerosolized calibrant stream and an outlet aperture; and a second conduit coupled to the outlet aperture and configured to transfer a gaseous calibrant stream from the outlet aperture to the analytical device, wherein the first conduit joins the second conduit join to form a single conduit for transfer of a combination of the gaseous contaminant stream and the gaseous calibrant stream to the analytical device.

Clause 2. The system of clause 1 further comprising a gas flow conduit to convey a gaseous sample stream from a gaseous sample source to the inlet aperture of the gas exchange device.

Clause 3. The system of clause 2 further comprising a mass flow controller connected to the gas flow conduit to control flow rate of the gaseous sample stream.

Clause 4. The system of clause 1 further comprising a mass flow meter interfaced between the gas exchange device and the analytical device.

Clause 5. The system of clause 1 wherein the gas exchange device comprises a cylindrical housing, extending along an axis, and enclosing a membrane for removal and transfer of particles from a gaseous sample stream to the gaseous contaminant stream, and an exchange gas inlet port and exchange gas outlet port.

Clause 6. The system of clause 1 further comprising a nebulizer connected to the inlet aperture of the spray chamber device to create an aerosolized calibrant stream from a liquid calibrant stream.

Clause 7. The system of clause 6 further comprising a liquid flow conduit to convey the liquid calibrant stream from a liquid calibrant source to the nebulizer of the inlet aperture of the spray chamber.

Clause 8. The system of clause 7 further comprising a mass flow controller connected to the liquid flow conduit to control flow rate of the liquid calibrant stream.

Clause 9. The system of clause 1 wherein the spray chamber is a glass spray chamber.

Clause 10. The system of clause 1 wherein the analytical device is an inductively coupled plasma-mass spectrometry (ICP-MS) or an inductively coupled plasma-optical emission spectrometry (ICP-OES).

Clause 11. A method of calibrating an analytical device and analyzing gas samples, the method comprising: a) transferring a gaseous sample stream from a gaseous sample source to a gas exchange device; passing the gaseous sample stream through the gas exchange device; injecting exchange gas through the gas exchange device countercurrent to the gaseous sample stream; passing an output of the gas exchange device to an analytical device; and monitoring an output flow rate of the gas exchange device; b) transferring a liquid calibrant stream from a liquid calibrant source to a nebulizer; injecting nebulizer gas into the nebulizer to form a nebulized liquid calibrant stream; injecting the nebulized liquid calibrant stream into a spray chamber; wherein a gaseous calibrant stream is separated from liquid; passing the gaseous calibrant stream of the spray chamber to the analytical device; and c) combining the output of the gas exchange device and the gaseous calibrant stream prior to the analytical device.

Clause 11. The method of clause 11 further comprising injecting makeup gas to the output from the gas exchange device to provide the output flow rate that is at least 98% of the flow rate of the gaseous sample stream from the gaseous sample source.

Clause 13. The method of clause 11 wherein at least 99.8% of gas of the gaseous sample stream is exchanged with the exchange gas in the first gas exchange device.

Clause 14. The method of clause 11 wherein the exchange gas is argon.

Clause 15. The method of clause 11 further comprising repeating the method for multiple liquid calibrant streams, each liquid calibrant stream containing a different amount of calibrant in order to calculate a calibration curve

Clause 16. The method of clause 11 wherein the gaseous sample stream contains at least one contaminant selected from the group consisting of transition metals and heavy metals

Clause 17. The method of clause 11 wherein the gaseous sample stream contains at least one contaminant selected from the group consisting of Na, Mg, Al, Mo, W, Pb, Ti, Cr, Fe, Ni, Co, Cu, Zn, K, Ca, and Mn and the liquid calibrant stream contains the at least one contaminant.

Clause 18. The method of clause 11 wherein the gaseous sample stream contains a moisture sensitive gas.

Clause 19. The method of clause 11 wherein the flow rate of the gaseous sample stream is 2 l/min and the flow rate of the liquid calibrant stream is at least 0.8 l/min.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A system configured to calibrate an analytical device and analyze gas samples, the system comprising at least a sample gas exchange apparatus and a calibration gas exchange apparatus;
the sample gas exchange apparatus comprising:
a first gas exchange device having an inlet aperture and an outlet aperture; and
a first conduit coupled to the outlet aperture and configured to transfer a gaseous contaminant stream from the outlet aperture to the analytical device,
the calibration gas exchange apparatus comprising:
a second gas exchange device having an inlet aperture to accept an aerosolized calibrant stream and an outlet aperture; and
a second conduit coupled to the outlet aperture and configured to transfer a gaseous calibrant stream from the outlet aperture to the analytical device,
wherein the first conduit and second conduit join to form a single conduit for transfer of a combination of the gaseous contaminant stream and the gaseous calibrant stream to the analytical device.

2. The system of claim 1 further comprising a gas flow conduit to convey a gaseous sample stream from a gaseous sample source to the inlet aperture of the first gas exchange device.

3. The system of claim 2 further comprising a mass flow controller connected to the gas flow conduit to control flow rate of the gaseous sample stream.

4. The system of claim 1 further comprising a mass flow meter interfaced between the first gas exchange device and the analytical device.

5. The system of claim 1 wherein the first gas exchange device comprises a cylindrical housing, extending along an axis, and enclosing a membrane for removal and transfer of particles from a gaseous sample stream to the gaseous contaminant stream, and an exchange gas inlet port and exchange gas outlet port.

6. The system of claim 1 further comprising a nebulizer connected to the inlet aperture of the second gas exchange device to create an aerosolized calibrant stream from a liquid calibrant stream.

7. The system of claim 6 further comprising a liquid flow conduit to convey the liquid calibrant stream from a liquid calibrant source to the nebulizer of the inlet aperture of the second gas exchange device.

8. The system of claim 7 further comprising a mass flow controller connected to the liquid flow conduit to control flow rate of the liquid calibrant stream.

9. The system of claim 1 further comprising a mass flow meter interfaced between the second gas exchange device and the analytical device.

10. The system of claim 1 wherein the second gas exchange device comprises a cylindrical housing, extending along an axis, and enclosing a membrane for removal and transfer of particles from the aerosolized calibrant stream to the gaseous calibrant stream, and an exchange gas inlet port and exchange gas outlet port.

11. The system of claim 1 wherein the analytical device is an inductively coupled plasma-mass spectrometry (ICP-MS) or an inductively coupled plasma-optical emission spectrometry (ICP-OES).

12. A method of calibrating an analytical device and analyzing gas samples, the method comprising:
a) transferring a gaseous sample stream from a gaseous sample source to a first gas exchange device; passing the gaseous sample stream through the first gas exchange device; injecting exchange gas through the first gas exchange device countercurrent to the gaseous sample stream; passing an output of the first gas exchange device to an analytical device; and monitoring an output flow rate of the first gas exchange device;
b) transferring a liquid calibrant stream from a liquid calibrant source to a second gas exchange device, wherein the liquid calibrant stream is aerosolized prior to the second gas exchange device; passing the aerosolized calibrant stream through the second gas exchange device; injecting exchange gas through the second gas exchange device countercurrent to the aerosolized calibrant stream; passing an output of the second gas exchange device to the analytical device; and monitoring an output flow rate at the second gas exchange device; and
c) combining the output of the first gas exchange device and the output of the second gas exchange device prior to the analytical device.

13. The method of claim 12 further comprising injecting makeup gas to the output from the first gas exchange device to provide the output flow rate that is at least 98% of the flow rate of the gaseous sample stream from the gaseous sample source.

14. The method of claim 12 wherein at least 99.8% of gas of the gaseous sample stream is exchanged with the exchange gas in the first gas exchange device.

15. The method of claim 12 wherein the exchange gas is Argon.

16. The method of claim 12 further comprising repeating the method for multiple liquid calibrant streams, each liquid calibrant stream containing a different amount of calibrant in order to calculate a calibration curve.

17. The method of claim 12 wherein the gaseous sample stream contains at least one contaminant selected from the group consisting of transition metals and heavy metals.

18. The method of claim 12 wherein the gaseous sample stream contains at least one contaminant selected from the group consisting of Na, Mg, Al, Mo, W, Pb, Ti, Cr, Fe, Ni, Co, Cu, Zn, K, Ca, and Mn and the liquid calibrant stream contains the at least one contaminant.

19. The method of claim 12 wherein the gaseous sample stream contains a moisture sensitive gas.

20. The method of claim 12 wherein the flow rate of the gaseous sample stream is 2 l/min and the flow rate of the liquid calibrant stream is at least 0.8 l/min.
